(19) United States
(12) Patent Application Publication
(10) Pub. No.: US 2006/0133906 A1
(43) Pub. Date: Jun. 22, 2006

(54) Transport vehicle with loading channel that extends for the entire length of the vehicle

(76) Inventor: H. William B. Wilt, Valleyview (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/303,681

(22) Filed: Dec. 15, 2005

(30) Foreign Application Priority Data
Dec. 17, 2004 (CA) 2,489,686

(51) Int. Cl. B60P 7/12

(52) U.S. Cl. 410/37

(57) ABSTRACT

A transport vehicle includes a vehicle body having a first end and second end. The vehicle body includes at least two discrete body portions with underlying wheel suspension. Each of the body portions has a top and a bottom. At least one bridge support extends transversely between the bottom of the body portions to define a recessed loading channel that extends between the first end and the second end of the body.

### FIELD OF THE INVENTION

The present invention relates to a transport vehicle which was originally developed for hauling pipe, logs, power poles and other types of elongated objects.

### BACKGROUND OF THE INVENTION

Due to their length, the transport of pipe, logs, and power poles has inherent problems. Objects extending rearward from a transport vehicle create a hazard for following traffic. Such objects also interfere with the ability of the transport vehicle to turn and navigate steep inclines.

### SUMMARY OF THE INVENTION

According to the present invention there is provided a transport vehicle, which includes a vehicle body having a first end and second end. The vehicle body includes at least two discrete body portions with underlying wheel suspension. Each of the body portions has a top and a bottom. At least one bridge support extends transversely between the bottom of the body portions to define a recessed loading channel that extends between the first end and the second end of the body. Drive means are provided for propelling the vehicle body forward. An operator station is mounted to one of the body portions, which is adapted to control the motion of the vehicle body.

The transport vehicle, as described above, has a loading channel which extends for the entire length of the vehicle, enabling it to better accommodate pipes, logs, power poles and other such elongated objects. The operator station is off to one side, out of the way. There are various additional features which can be added to further increase the utility of the vehicle, as will be hereinafter described. The loading channel can be made open ended, so that the elongated objects extend both forwardly and rearwardly from the vehicle. The bridge support can be made to pivot out of the way to permit rapid unloading of the elongated objects from the loading channel. The body portions can be connected to a length adjustable lateral support which, when unloaded, enables the width of the vehicle to be arbitrarily altered.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a front perspective view of a preferred embodiment of transport vehicle constructed in accordance with the teachings of the present invention.

FIG. 2 is a rear perspective view of the transport vehicle illustrated in FIG. 1, with the vehicle in the process of loading.

FIG. 3 is a side elevation view of the transport vehicle illustrated in FIG. 1.

FIG. 4 is an end elevation view of the transport vehicle illustrated in FIG. 1, with the vehicle in the process of unloading.

FIG. 5 is a front perspective view of the transport vehicle illustrated in FIG. 1, with the vehicle in the process of making a lateral adjustment.

FIG. 6 is a front perspective view of a simplified alternative embodiment of transport vehicle constructed in accordance with the teachings of the present invention.

FIG. 7 is a rear perspective view of the transport vehicle illustrated in FIG. 6, with the vehicle in the process of loading.

FIG. 8 is a rear perspective view of an alternative embodiment of transport vehicle constructed in accordance with the teachings of the present invention relating to lateral adjustment, the vehicle being illustrated in an laterally expanded condition.

FIG. 9 is a rear perspective view of the transport vehicle illustrated in FIG. 8, with the vehicle in a laterally retracted condition.

### DETAILED DESCRIPTION OF THE PREFERRED EMBODIMENT

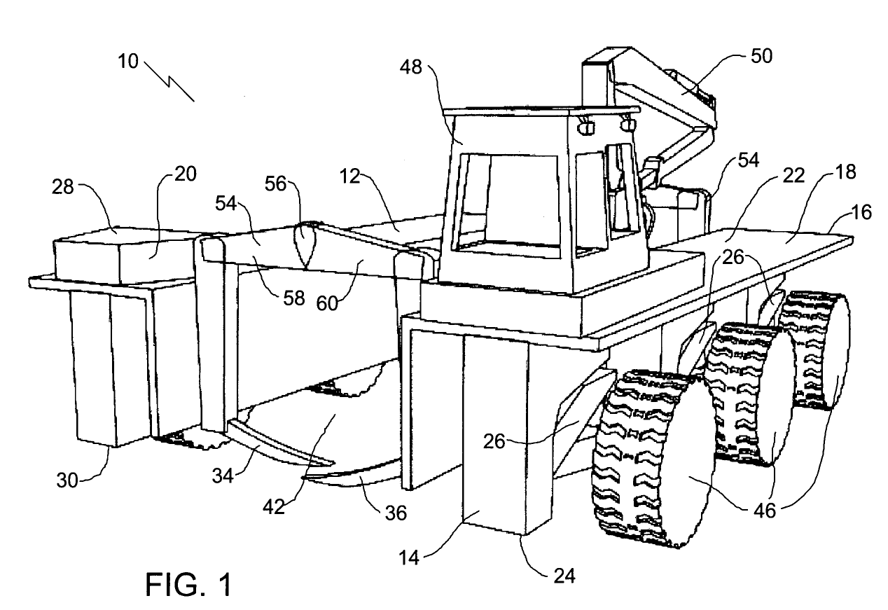

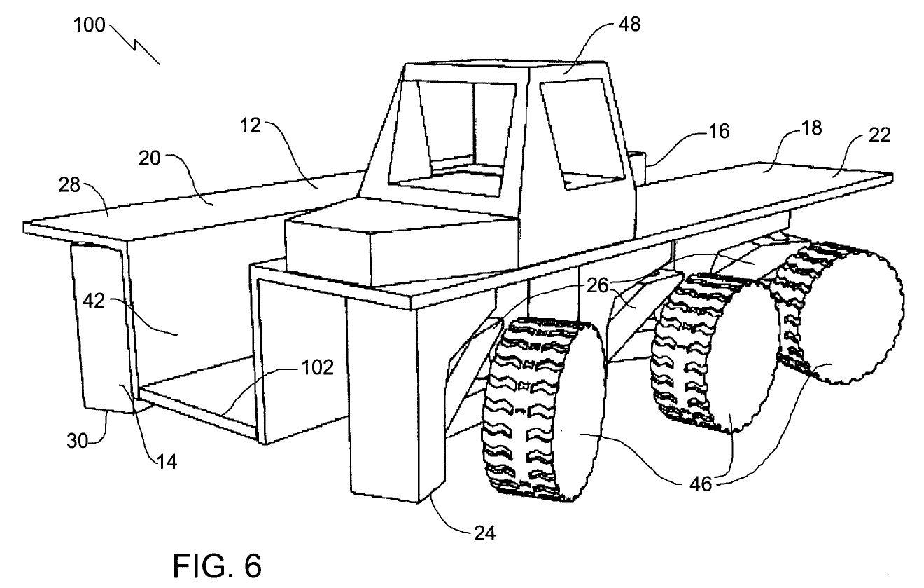

The preferred embodiment, a transport vehicle, generally identified by reference numeral 10, will now be described with reference to FIGS. 1 through 5. Two alternative embodiments, which were concurrently developed, use only selected features of the preferred embodiment. These alternative embodiments will be described with reference to FIGS. 6 and 7, 8 and 9.

Structure and Relationship of Parts:

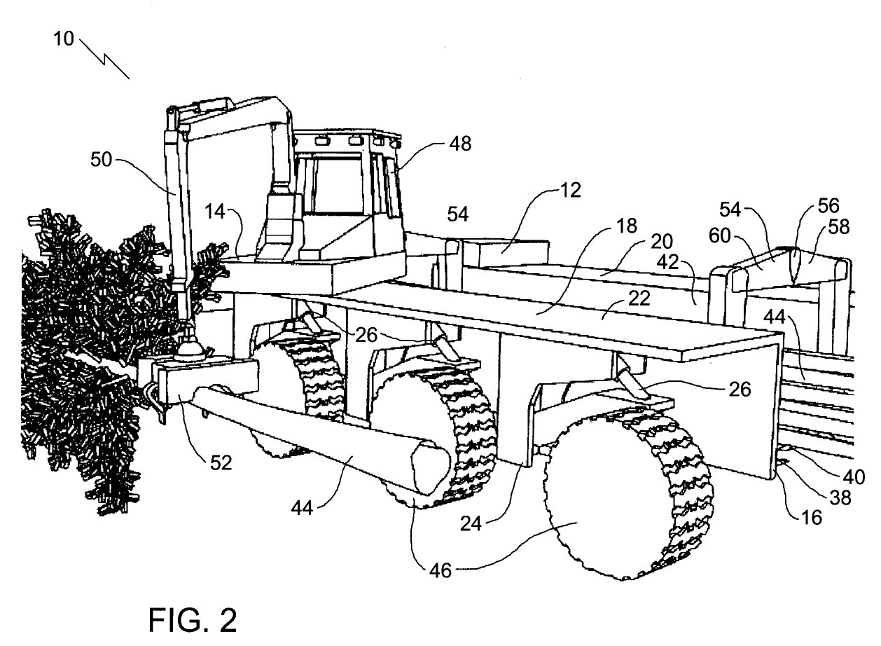

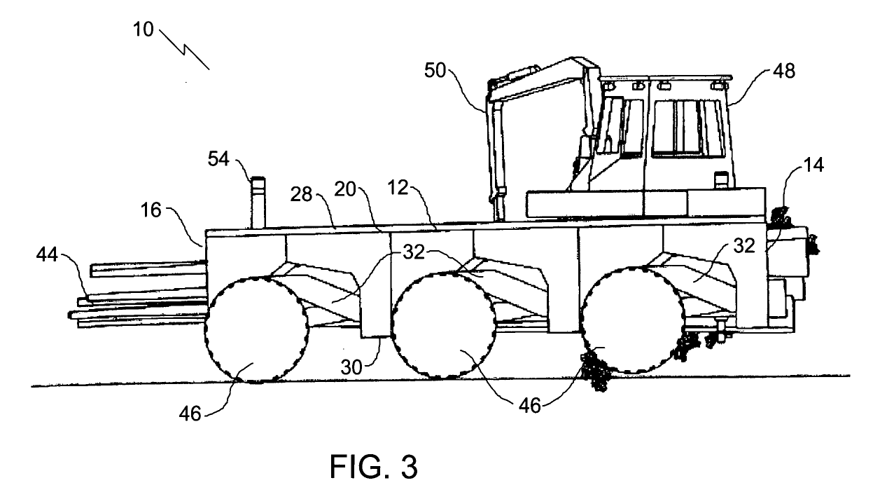

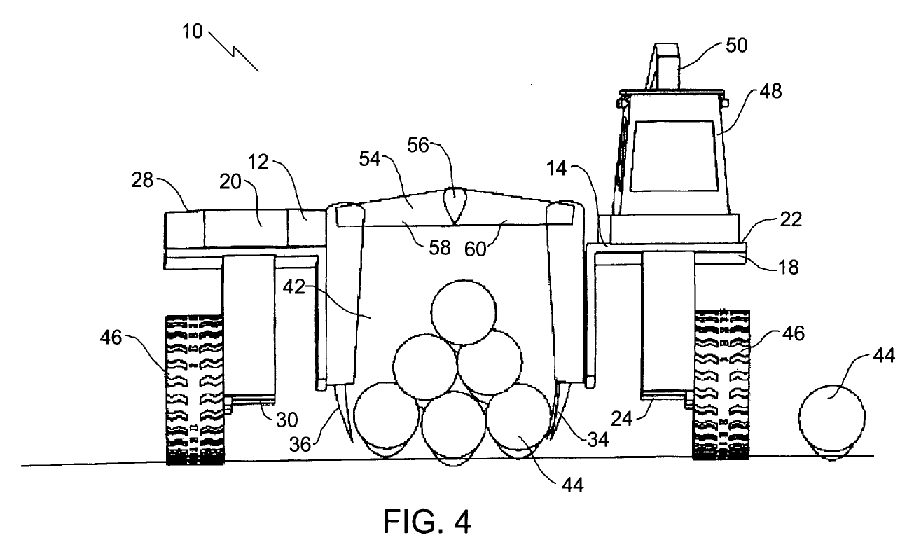

Referring to FIGS. 1 and 3, transport vehicle 10 has a vehicle body 12 having a first end 14 and second end 16. Referring to FIG. 4, body 12 consists of a discrete elongated first body portion 18 and a discrete elongated second body portion 20. Referring to FIGS. 1 and 2, first body portion 18 has a top 22, a bottom 24 and several underlying wheel suspension modules 26. Suspension modules 26 are capable of being made rigid by locking them, such as by closing the hydraulic valves. This is useful when transport vehicle is not moving and is being loaded to prevent unnecessary wear and damage of suspension modules. They can then be unlocked for transport. Referring to FIG. 3, second body portion 20 also has a top 28, a bottom 30 and several underlying wheel suspension modules 32. Referring to FIG. 1, a first pair of bridge support members 34 and 36 are positioned at first end 14 of body 12. Referring to FIG. 2, a second pair of bridge support members 38 and 40 are positioned at second end 16 of body 12. Referring to FIG. 1 with respect to bridge support members 34 and 36 and FIG. 2 with respect to bridge support members 38 and 40, each pair of bridge support members extend transversely between bottom 24 of first body portion 18 and bottom 30 of second body portion 20 to define an open ended recessed loading channel 42. Loading channel 42 extends between first end 14 and second end 16 of body 12. Each pair of bridge support members includes a first bridge support member (34 and 38, respectively) pivotally mounted to first body portion 18 for pivotal movement about a first substantially horizontal pivot axis and a second bridge support member (36 and 40, respectively) pivotally mounted to second body 20 for pivotal movement about a second substantially horizontal pivot axis. The pairs of bridge support members pivot between a substantially horizontal closed position, as illustrated in FIG. 1, closing the bottom of the loading channel and a downwardly inclined open position, as illustrated in FIG. 4. Referring to FIGS. 2 and 3, it can be seen how elongated objected are positioned in loading channel 42 when the bridge supports are in the closed position. The elongated objects chosen for purposes of illustration are logs 44. Referring to FIG. 4, logs 44 are unloaded from the loading channel by moving the bridge supports to the open position. In the illustrated embodiment bridge support members have been made as grapples. When deploying bridge support members their movement is downward and then inward. This enables logs to be loaded by straddling a pile of logs with the bridge supports in the open position, and closing them such that the logs are lifted from the ground.

Some form of drive means is required for propelling vehicle body 12 forward. Transport vehicle 10 has been constructed as an “all terrain” vehicle, which is able to traverse rough terrain. For this application, the drive means consists of drive motors (not illustrated) which drive each individual wheel 46. It will be understood that tracks may be substituted for wheels 46 to adapt transport vehicle 10 for use in environments where tracks are preferable.

An operator station 48 is mounted to one of body portions 18 and 20. In the drawings provided, operator station 48 is mounted on top 22 of first body portion 18. From operator station 48 an operator can control the motion of transport vehicle 10.

Referring to FIG. 2, in any application concerning elongated objects, it is preferred that a loading boom 50 be provided for the purpose of loading elongated objects into loading channel 42. As illustrated, operator station 48 pivots about a substantially vertical pivot axis, with loading boom 50 carried by operator station 48. This enables 20 loading boom 50 to be swung to either side of first body portion 18. In the illustrated application, the elongated objects are logs 44, as opposed to pipes or power poles. Loading boom 50 is, therefore, illustrated as being equipped with a single grip head 52, which is used to cut down a tree and then remove the limbs. The resulting logs 44 are then loaded into loading channel 42 of transport vehicle 10.

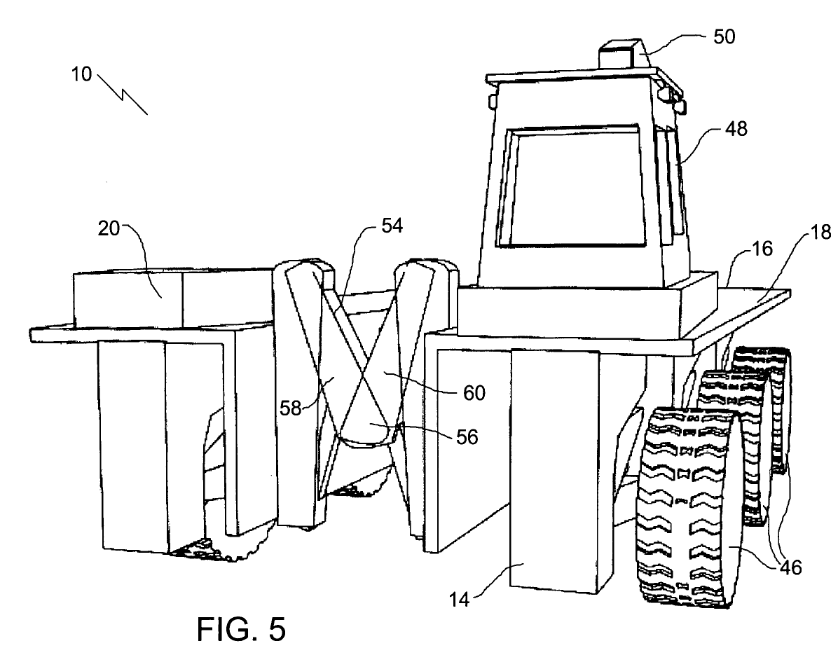

Referring to FIGS. 1 and 3, it can be seen that lateral supports 54 maintain the relative spacing of first body portion 18 and second body portion 20. Referring to FIG. 5, it is preferred that lateral supports 54 be adjustable to permit the distance between first body portion 18 and second body portion 20 to be adjusted. To facilitate this distance adjustment, each of lateral supports 54 has a hinge 56 positioned at it's midpoint that defines a substantially horizontal pivot axis. Hinge 56 divides each lateral support 54 into two portions 58 and 60. Portions 58 and 60 pivot at hinge 56 to bring the two portions from a linear orientation as illustrated in FIGS. 1 and 4, toward a parallel orientation (not shown). Referring to FIG. 5, lateral support 54 is illustrated in an intermediate position moving from the linear orientation toward the parallel orientation. The linear orientation is a useful position for loading, while the parallel position is a transport position, for situations in which width is an issue, although any intermediate position may be used to give the desired clearance or loading capabilities. For example, width may be an issue when loading transport vehicle 10 onto a flat deck transport truck for movement from one job site to another, in which the parallel position may be the most desirable. Width may also be an issue in driving transport vehicle 10 through a gate to between obstacles in order to reach a working area, where an intermediate position may suffice.

Operation:

The operation of transport vehicle 10 will now be described with reference to FIGS. 1 through 5. Transport vehicle 10 is an all terrain vehicle which is not intended to drive down major highways for long distances. It is, therefore, prepared for transport by pivoting portions 58 and 60 of lateral supports 54 at hinge 56 to bring the two portions from the linear orientation illustrated in FIG. 1 into a narrower more compact form, which may at completed folded into a parallel orientation or a partially folded orientation, as illustrated in FIG. 5. Once at a work site, lateral supports 54 of transport vehicle 10 are returned to the linear orientation illustrated in FIG. 1. Referring to FIG. 2, single grip head 52 is used to cut down trees and then remove all limbs to turn the trees into logs 44. Loading boom 50 then lifts logs 44 and positions them into loading channel 42, where there are supported by the bridge support members. It is important to note that although only bridge support members 38 and 40 are visible in FIG. 2, they are also supported by bridge support members 34 and 36, as illustrated in FIG. 1. Referring to FIG. 3, logs 44 extend both forward of first end 14 and rearward of second end 16 of body 12. This enables longer loads to be handled in a more balanced condition. Referring to FIG. 4, logs 44 are unloaded from loading channel 42 by pivoting bridge support members 34, 36, 38, and 40 from the substantially horizontal closed position illustrated in FIG. 1, closing the bottom of the loading channel to the downwardly inclined open position, as illustrated in FIG. 4.

Variations:

Transport vehicle 10 has numerous features, not all of which may be required for a particular application. In the course of developing transport vehicle 10, two variations were developed using some, but not all, of the features.

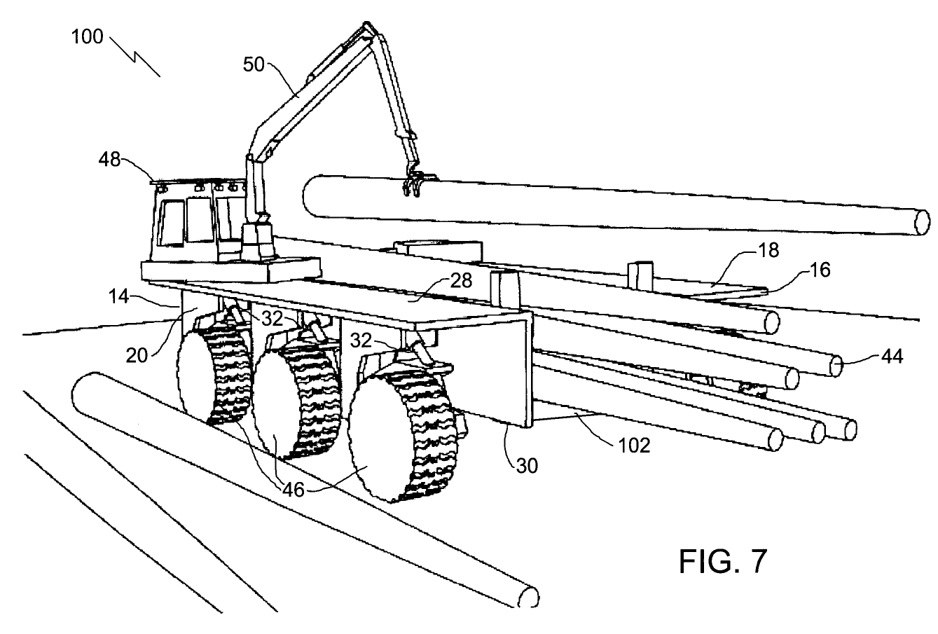

Referring to FIGS. 6 and 7, a transport vehicle 100 is illustrated which has a vehicle body 12 having a first end 14 and second end 16. Body 12 consists of a discrete elongated first body portion 18 and a discrete elongated second body portion 20. Referring to FIG. 6, first body portion 18 has a top 22, a bottom 24 and several underlying wheel suspension modules 26. Referring to FIG. 7, second body portion 20 also has a top 28, a bottom 30 and several underlying wheel suspension modules 32. The embodiment shown in FIG. 7 is designed to follow behind, for example, a feller buncher to pick up and transport the logs. Unlike the preferred embodiment of transport vehicle 10, transport vehicle 100 has a single fixed bridge support 102 extending transversely between bottom 24 of first body portion 18 and bottom 30 of second body portion 20 to define an open ended recessed loading channel 42 that extends between first end 14 and second end 16 of body 12. The drive means for propelling transport vehicle 100 forward are drive motors (not illustrated), which drive each individual wheel 46. An operator station 48 is mounted to first body portion 18. Operator station 48 rotates about a substantially vertical pivot axis and has a boom 50, which is carried by it. It will be apparent to one skilled in the art, that transport vehicle 100 is the same as transport vehicle 10 except for the dumping capability, the ability to straddle and pick up a pile of logs and the lateral adjustment capability.

An advantage of the variation in FIG. 6, not originally anticipated but subsequently determined, is that it can also be used to ferry vehicles over muskeg or other difficult terrain to get to a remote worksite, such as an oil well site. Vehicles can drive into loading channel from one end and drive out of load channel from the other end, once transport vehicle has crossed an environmentally sensitive area to a working area. In that situation, a road would not need to be constructed in an environmentally sensitive area if it was not environmentally desirable or simply not cost effective to do so.

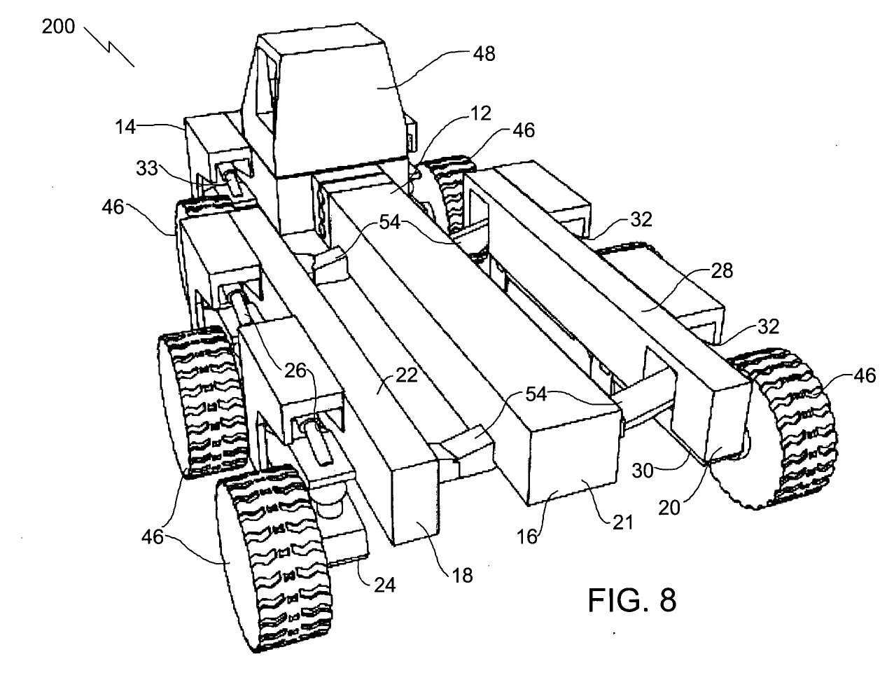

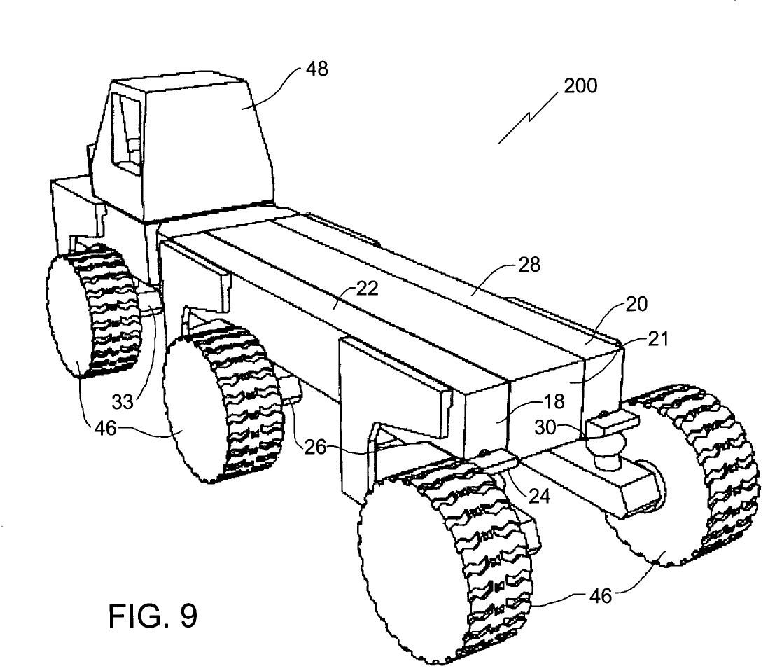

Referring to FIGS. 8 and 9, transport vehicle 200 consists of a vehicle body 12 having a first end 14 and second end 16. Body 12 consists of a number of discrete body portions 18, 20, and 21. Body portion 18 has a top 22, a bottom 24 and several underlying wheel suspension modules 26. Body portion 20 also has a top 28, a bottom 30 and several underlying wheel suspension modules 32. Body portion 21 has underlying wheel suspension modules 33 at first end 14, and is suspended between body portions 18 and 20 at second end 16 of body 12. Length adjustable lateral supports 54 are positioned between body portions 18 and 21 and between body portions 20 and 21 at each of first end 14 and second end 16 of body 12. This allows the distance between body portions 18, 20 and 21 to be adjusted, as can be seen from a comparison of FIGS. 8 and 9. Drive motors within wheels 46 serve as drive means for propelling transport vehicle 200 forward. A fixed operator station 48 is mounted to body portion 21, from which motion of transport vehicle 200 is controlled. It will be apparent to one skilled in the art, that the lateral adjustment capability is demonstrated in transport vehicle 200, without many of the other features a number of transport vehicle 10.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

What is claimed is:

1. A transport vehicle, comprising:
a vehicle body having a first end and second end, the body being comprised of:
at least two discrete body portions with underlying suspension, each of the body portions having a top and a bottom;
at least one bridge support extending transversely between the bottom of the body portions to define a recessed loading channel that extends between the first end and the second end of the body;
drive means for propelling the vehicle body forward; and
an operator station mounted to one of the body portions adapted to control the motion of the vehicle body.

2. The transport vehicle as defined in claim 1, wherein the at least one bridge support is fixed.

3. The transport vehicle as defined in claim 1, wherein the at least one bridge support pivots between an open position and a closed position, such that elongated objects are placed into the loading channel when the at least one bridge support is in the closed position and the elongated objects are unloaded from the loading channel by moving the at least one bridge support to the open position.

4. The transport vehicle as defined in claim 3, wherein the bridge supports are grapples capable of picking up underlying loads of elongated objects straddled by the vehicle body.

5. The transport vehicle as defined in claim 1, wherein means are provided for locking the suspension during loading.

6. The transport vehicle as defined in claim 1, wherein the loading channel is open ended, thereby accommodating elongated objects that are longer than the body.

7. The transport vehicle as defined in claim 1, wherein a loading boom is mounted to one of the body portions.

8. The transport vehicle as defined in claim 1, wherein length adjustable lateral supports are provided between the body portions, whereby the distance between the body portions is adjustable.

9. The transport vehicle as defined in claim 8, wherein each of the lateral supports has a hinge positioned at a midpoint of the lateral support, the hinge dividing the lateral support into two portions and facilitating pivotal movement about a substantially horizontal pivot axis to bring the two portions from a linear orientation toward a parallel orientation.

10. The transport vehicle as defined in claim 1, wherein the body portions consist of a first body portion and a second body portion.

11. The transport vehicle as defined in claim 1, wherein the suspension has wheels and the drive means consists of drive motors within individual wheels.

12. A transport vehicle, comprising:
a vehicle body having a first end and second end, the body being comprised of:
a discrete elongated first body portion having a top, a bottom and an underlying wheel suspension;
a discrete elongated second body portion having a top, a bottom and an underlying wheel suspension;
a single fixed bridge support extending transversely between the bottom of the first body portion and the bottom of the second body portion to define an open ended recessed loading channel that extends between the first end and the second end of the body;
drive means for propelling the vehicle body forward; and
an operator station mounted to one of the body portions adapted to control the motion of the vehicle body.

13. A transport, comprising:
a vehicle body having a first end and second end, the body being comprised of:
a discrete elongated first body portion having a top, a bottom and an underlying suspension with one of wheels or a track, means being provided to lock the suspension to keep the suspension rigid during loading;
a discrete elongated second body portion having a top, a bottom and an underlying wheel suspension with one of wheels or a track, means being provided to lock the suspension to keep the suspension rigid during loading;
a first pair of bridge support members positioned at the first end of the body and a second pair of bridge support members positioned at the second end of the body, each pair of bridge support members extending transversely between the bottom of the first body portion and the bottom of the second body portion to define an open ended recessed loading channel between the first end and the second end of the body, each pair of bridge support members including a first bridge support member pivotally mounted to the first body for pivotal movement about a first substantially horizontal pivot axis and a second bridge support member pivotally mounted to the second body for pivotal movement about a second substantially horizontal pivot axis, the pairs of bridge support members pivoting between a substantially horizontal closed position closing the bottom of the loading channel and a downwardly inclined open position, such that elongated objects placed into the loading channel when the bridge supports are in the closed position are unloaded from the loading channel by moving the bridge supports to the open position, the bridge supports being in the form of grapples capable of picking up an underlying pile of elongated objects that the vehicle body is straddling;
drive means for propelling the vehicle body forward; and
an operator station mounted to one of the body portions adapted to control the motion of the vehicle body.

14. The transport vehicle as defined in claim 13, wherein a loading boom is mounted to one of the body portions.

15. The transport vehicle as defined in claim 13, wherein length adjustable lateral supports are provided between the body portions, whereby the distance between the body portions is adjustable.

16. The transport vehicle as defined in claim 13, wherein the drive means consists of drive motors within individual wheels.

17. A transport vehicle, comprising:
a vehicle body having a first end and second end, the body being comprised of:
at least two discrete body portions with underlying suspension, each of the body portions having a top and a bottom;
length adjustable lateral supports positioned between the body portions at each of the first end and the second end of the body, whereby the distance between the body portions is adjustable;
drive means for propelling the vehicle body forward; and
an operator station mounted to one of the body portions adapted to control the motion of the vehicle body.

18. The transport vehicle as defined in claim 17, wherein each of the lateral supports has a hinge positioned at a midpoint of the lateral support, the hinge dividing the lateral support into two portions and facilitating pivotal movement about a substantially horizontal pivot axis to bring the two portions from a linear orientation toward a parallel orientation.
